(19) United States
(12) Patent Application Publication
(10) Pub. No.: US 2005/0253941 A1
(43) Pub. Date: Nov. 17, 2005

(54) Image processing circuit, image processing method, and camera device

(75) Inventor: Yoshihiro Taura, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 10/516,412

(22) PCT Filed: Jun. 6, 2003
(86) PCT No.: PCT/JP03/07207

§ 371 Date: Dec. 2, 2004

(30) Foreign Application Priority Data
Jun. 6, 2002 (JP) 2002-165127

(51) Int. Cl. H04N 5/335

(52) U.S. Cl. 348/272

(57) ABSTRACT

An image processing circuit, image processing method, and camera device for effectively removing color changes included in an input image and improving the quality of the output image signal, wherein an image signal picked up by an image pickup device is input to a digital signal processing circuit 104 which separates it into RGB color signals and a luminance signal. The integrated values of the separated color signals are monitored for each field and when the integrated value of B becomes smaller than a judgment threshold and again starts to become larger, it is judged if a color rolling phenomenon has occurred. Further, when it is judged that there is a color rolling phenomenon, the color rolling suppression mode is shifted to and the auto white balancing (AWB) is speeded up and control is performed to suppress the gain of the Ye direction color signal. Further, when it is judged that there is no color rolling phenomenon, the auto white balancing AWB) of the usual mode is performed.

### TECHNICAL FIELD

The present invention relates to an image processing circuit, image processing method, and camera device able to suppress color changes included in an input image and obtain a high grade output image.

### BACKGROUND ART

In the past, when photographing an object by a camera device, a phenomenon occurs where periodic color changes are included in the captured image due to the lighting of the photographed location etc., that is, color rolling or color flicker.

For example, if photographing an object under fluorescent light with a 60 [Hz] power source in a camera device based on the general NTSC standard (1 field 59.94 [Hz]), long period color changes (color rolling) occur.

The above-mentioned color rolling is a problem since the period of occurrence is not constant, so accurate detection is difficult and measures against it are not easy.

For example, in the disclosure of Japanese Unexamined Patent Publication (Kokai) No. 11-285010, the fact of being under fluorescent lighting is detected by an external sensor, but this requires provision of an external sensor, so there is the defect of inviting increased cost.

Further, as the method of suppressing color rolling, the method of increasing the speed of the auto white balance adjustment operation is used, but with just this, there is the problem that the phenomenon cannot be suppressed completely.

That is, even if increasing the speed of auto white balance adjustment so that adjustment is completed in a time of 2 seconds to 4 seconds or so, the speed of color change of the color rolling will rise far above that, so the rolling will not be able to be effectively handled.

FIG. 1 is an explanatory view of the color rolling phenomenon as seen by a vector scope. In FIG. 1, the abscissa shows the amplitude (gain) of the color difference signal B-Y, while the ordinate shows the amplitude of the color difference signal R-Y.

As shown in FIG. 1, in color rolling, sudden color changes occur mainly in the direction of the yellow light, but if adjusting this to match with the white color at a high speed by the white balance, the center of the width of change is made white, so it is not possible to completely suppress the color. Further, there is the problem that the color in the opposite direction also ends up occurring.

That is, when color rolling occurs, if adjusting the white balance with it, it is not possible to suppress just that color component. Convergence occurs by the average of the color components as a whole.

Specifically, when color rolling such as shown in FIG. 2A occurs, if adjusting the white balance with it, ideally it should be possible to completely suppress the color such as shown in FIG. 2B, but in actuality, the convergence occurs by the average of the color components as a whole as shown in FIG. 2C.

### DISCLOSURE OF INVENTION

An object of the present invention is to provide an image processing circuit, image processing method, and camera device able to effectively remove color changes included in an input image and improve the quality of the output image signal.

To achieve this object, the image processing circuit of the first aspect of the invention has a signal processing means for extracting prime color signals from an input image signal and a color change detecting means for detecting color changes included in the image signal based on integrated data of each prime color signal extracted by the signal processing means.

The second aspect of the present invention is an image processing method for processing an image signal comprising a first step of extracting prime color signals from the image signal, a second step of calculating integrated data of each color signal based on the extracted prime color signals, and a third step of extracting color changes included in the image signal based on changes in the integrated data of each color signal.

The third aspect of the present invention has an image pickup means for picking up an image of an object and outputting an image signal, a signal processing means for extracting prime color images from the image signal output from the image pickup means, a color signal detecting means for calculating integrated data for each color signal based on the prime color signals extracted by the signal processing means, and a color change detecting means for detecting color changes included in the image signal based on changes of integrated data of each color signal calculated by the color signal detecting means.

According to the present invention, the R (red), G (green), and B (blue) prime color signals are extracted from the image signal and the integrated data of each color signal is calculated based on the extracted RGB prime color signals.

Further, for example periodic color changes included in an image signal is detected based on the changes in the integrated data of each color signal calculated.

### BRIEF DESCRIPTION OF DRAWINGS

FIG. 1 is an explanatory view of the color rolling phenomenon as seen by a vector scope.

FIGS. 2A to C are views for explaining problems when increasing the speed of a white balance adjustment operation when the color rolling phenomenon occurs.

FIG. 3 is a block diagram of an example of the configuration of a camera device according to an embodiment of the present invention.

FIG. 4 is an explanatory view of changes of color signals at the time of color rolling.

FIG. 5 is a flow chart showing a routine for processing for suppressing color rolling in a camera device shown in FIG. 3.

### BEST MODE FOR CARRYING OUT THE INVENTION

Below, embodiments of an image processing circuit, image processing method, and camera device according to the present invention will be explained with reference to the attached drawings.

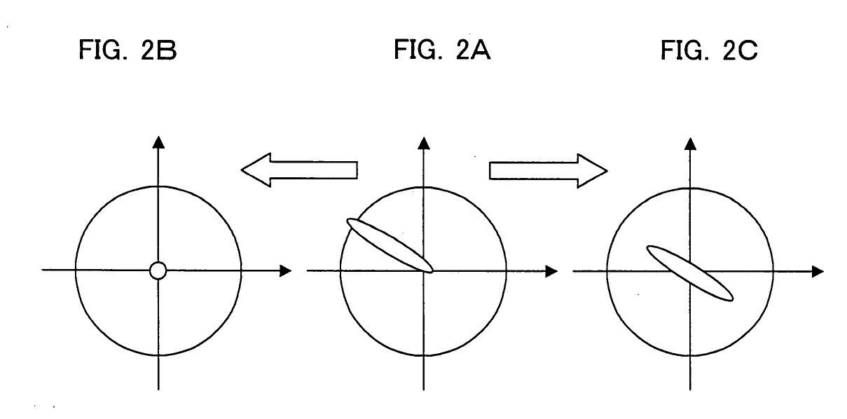

FIG. 2 is a block diagram of an example of the configuration of a camera device according to an embodiment of the present invention.

The camera device of this embodiment has a lens 101, a CCD image pickup device 102, a correlation double sampling/automatic gain control (hereinafter referred to as a “CDS/AGC”) circuit 103, a digital signal processing circuit 104, and a timing generator (TG) 105.

The CCD image pickup device 102 converts an optical signal obtained through the lens 101 to an electrical signal and outputs it as an image signal.

The CDS/AGC circuit 103 removes pixel noise by the CDS (correlation double sampling) from the image signal output from the CCD image pickup device 102, adjusts the gain by the AGC, and outputs the signal to the digital signal processing circuit 104.

The digital signal processing circuit 104 is comprised by a DSP (digital signal processor) and performs various processing on the image signal input from the CDS/AGC circuit 103.

Further, the timing generator (TG) 105 outputs various types of timing signals for the operation of the different parts of the camera device of this embodiment.

Next, the configuration of the digital signal processing circuit 104 characterizing the camera device of this embodiment will be explained.

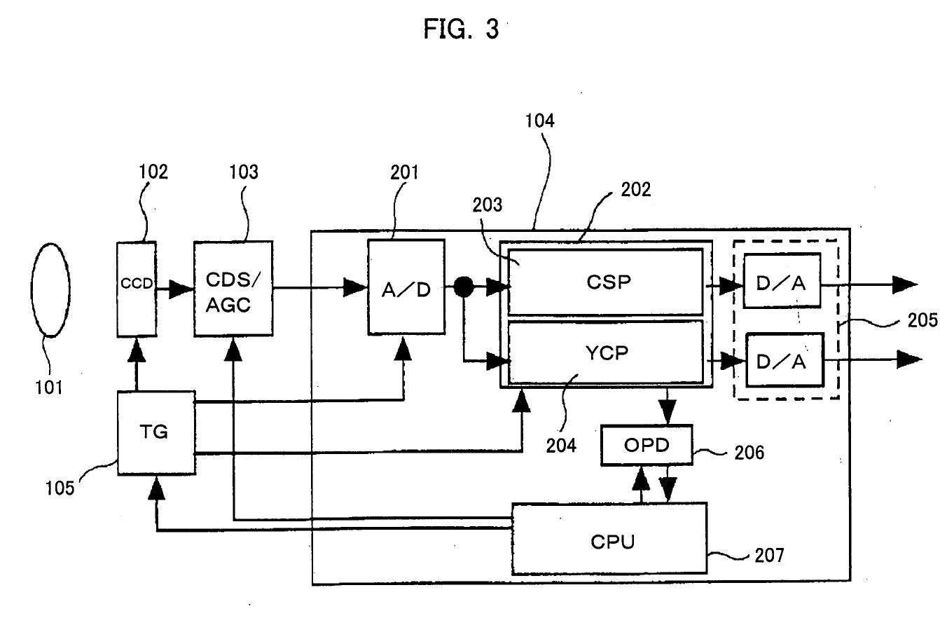

As shown in FIG. 3, the digital signal processing circuit 104 has an analog/digital (A/D) conversion unit 201, a signal processing unit 202 including a color signal processing unit (CSP) 203 and a luminance signal processing unit (YSP) 204, a digital/analog (D/A) conversion unit 205, an optical detector (OPD) unit 206, and an operational processing unit (CPU) 207 comprised of a microcomputer.

The A/D conversion unit 201 converts the analog image signal input from the CDS/AGC circuit 103 to a digital image signal and outputs the digitalized image signal to the signal processing unit 202.

The signal processing unit (signal processing means) 202, while not illustrated in FIG. 3, is provided with a color separating unit for separating the input image signal to R (red), G (green), and B (blue) color signals (C) and a luminance signal (Y). The separated color signals and luminance signal are input to the color signal processing unit (color signal detecting means) 203 and luminance signal processing unit 204. These are processed and output to the D/A conversion unit 205.

The D/A conversion unit 205 returns the processed digital image signal to an analog image signal and outputs it to the later image output circuit (not shown).

The optical detector unit (color change detecting means) 206 integrates the image signal acquired from the signal processing unit 202 for white balancing in the color signal processing unit 203.

The operational processing unit 207 performs white balancing based on the integrated value output by the optical detector 206.

The white balancing is performed by software in the operational processing unit 207 based on the color signals integrated by the optical detector 206 from the color signal processing circuit 203.

Here, for detection of the color rolling (or color flicker), the color (R, G, B) signals integrated by the optical detector 206 are used.

Normally, the OPD data will never have repeated extreme changes in data. At this time, there is no problem even with an auto white balancing operation if slowly performed.

Further, when a sporadic extreme change in data occurs, it does not mean that the color temperature conditions of the object have greatly changed. In almost all cases, it means that the object itself has changed to another object. Therefore, at this time, it is also possible not to perform the auto white balancing.

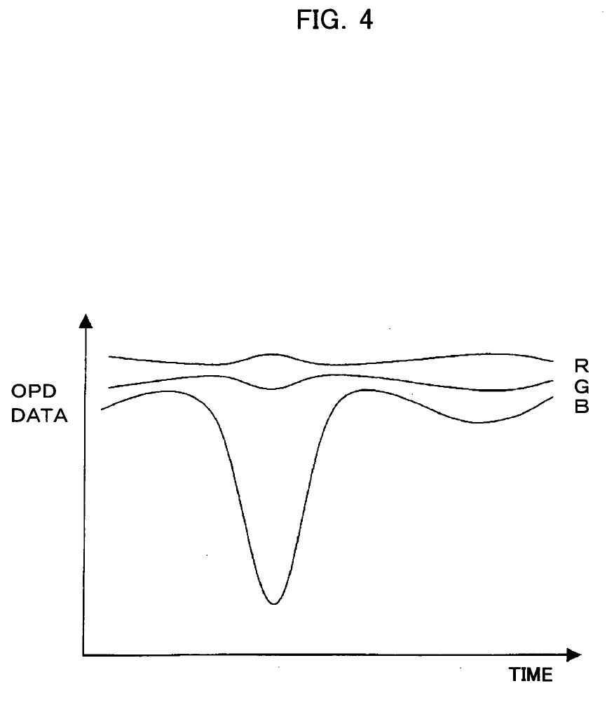

On the other hand, at the time of color rolling, as shown in FIG. 4, the integrated value of B becomes extremely small compared with the integrated values of R and G and this change is repeated. Further, the period of this change is random.

Therefore, the integrated value for each field (in the case of NTSC, 1/60 [s] and in the case of PAL, 1/50 [s]) is monitored and when the integrated value of B becomes smaller than a judgment threshold and starts to become larger again it is judged that color rolling has occurred.

Further, when it is judged that color rolling has been detected, the following two measures are taken:

(1) The speed of convergence of the auto white balancing is increased.

(2) The gains of the color signals of the B (blue) and Ye (yellow) directions are suppressed.

Here, the convergence speed of the auto white balancing is set for convergence of something usually taking several seconds in 1 field to 2 fields. That is, the waiting etc. of all processings are completely eliminated and the gains are calculated based on the OPD data to shorten the time until they are reflected back into the white balance amplifier. By doing this, it is possible to give sufficient trackability to rapid color changes.

In white balancing, normally waiting is performed. This wait indicates the time for performing processing a single time for several fields or for dealing with the next change after entering an insensitive zone (having a certain degree of width and after which being entered it is judged that a white balance has been reached).

In this embodiment, for the operation for adjustment of the auto white balancing (AWB) at as high a speed as possible, the waiting in the auto white balancing etc. are completely eliminated.

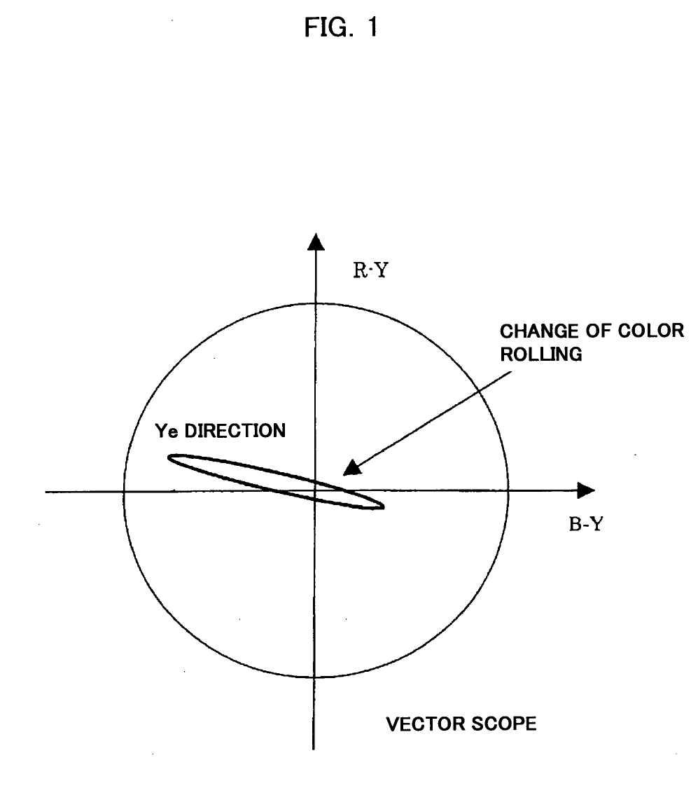

Further, to suppress the gains of the color signals in the B direction and Ye direction, the colors in the second quadrant and fourth quadrant are independently. controlled at the coordinates comprised of the R-Y axis and B-Y axis shown in FIG. 1.

In this embodiment, the color balances in all of the first to fourth quadrants are not simultaneously controlled. The embodiment is configured so that the color balance is adjusted independently for each of the first to fourth quadrants. The “colors in the second quadrant and fourth quadrant are independently controlled” spoken of here means that color adjustment is performed to suppress the color of the color rolling without changing the color balance of the other quadrants.

Due to this, only the color of the color rolling is suppressed and other colors are left and appear natural.

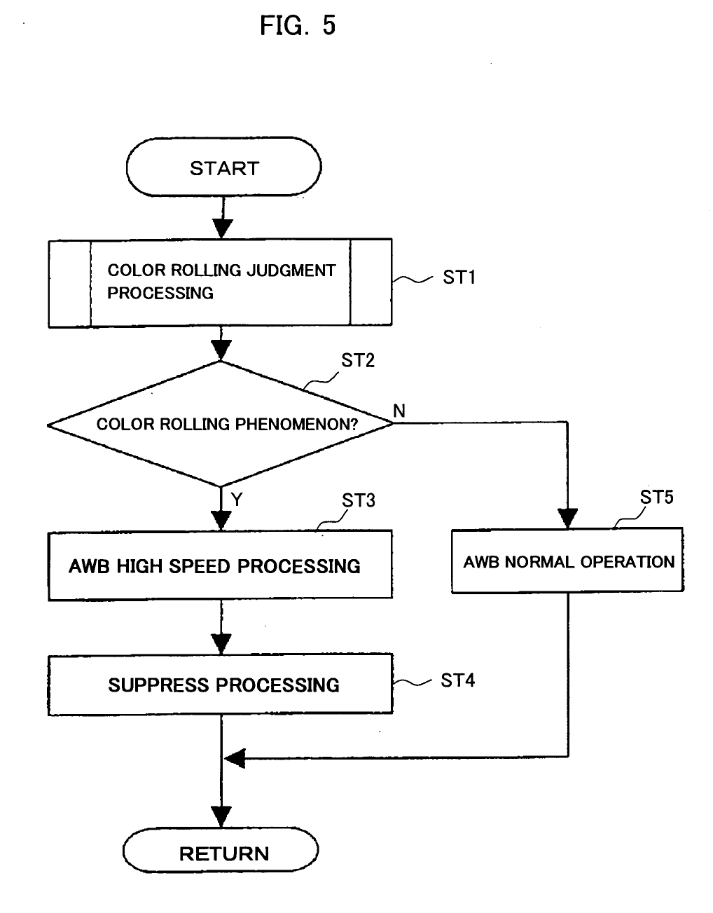

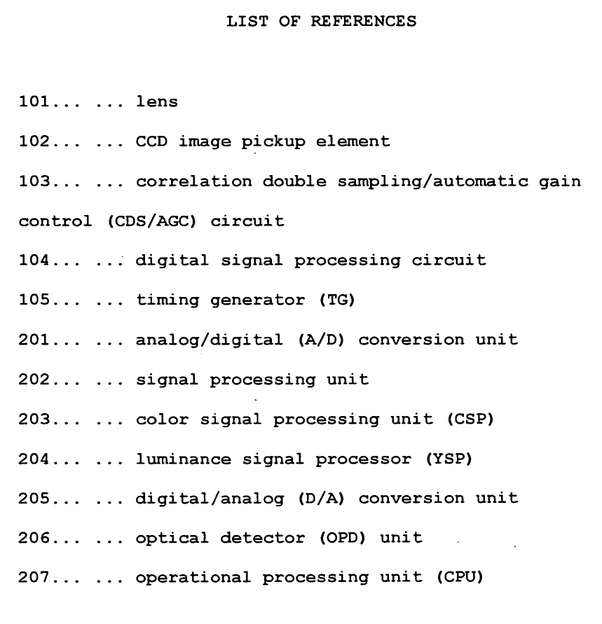

FIG. 5 is a flow chart of the routine of processing for suppressing color rolling according to the above embodiment.

First, at steps ST1 and ST2, the integrated values of the color signals (OPD data) are monitored for each field and when the integrated value of B becomes smaller than the judgment threshold and starts to become larger again, it is judged that the color rolling phenomenon has occurred.

Further, when judging that there is a color rolling phenomenon at step ST2, the color rolling suppression mode is shifted to, the above-mentioned auto white balancing (AWB) is speeded up (step ST3), and the control for suppressing the gain of the color signals of the B and Ye directions is performed (step ST4).

Further, when it is judged that there is no color rolling phenomenon, the auto white balancing (AWB) of the usual mode is performed (step ST5).

Note that as the configuration for auto white balancing, it is for example possible to use the one disclosed in Japanese Unexamined Patent Publication (Kokai) No. 11-243557.

Due to the processing of the above embodiment, it is possible to obtain the following effects:

(1) For example at the time of capturing an image under fluorescent lighting, periodic color changes can be suppressed and the quality of the camera image can be improved.

(2) It is possible to match the output image with the view by the naked eye. Therefore, it is possible to prevent mistakes when someone visually judges colors by a monitoring camera etc.

(3) By utilizing the fact that the color changes of the image have been suppressed, MPEG or other image compression can be performed more effectively. That is, the compression rate can be raised.

Note that above an example of application of the present invention to a camera device was explained, but the present invention can also be configured by an image processing circuit alone or an image processing method alone.

Further, the camera device may be one using a means other than a solid state image pickup device as the image pickup means. Further, it is possible to apply the invention to a configuration processing an image signal input by a means other than an image pickup means.

Further, the camera device includes a camera, mobile phone, personal computer (PC), or other electronic device having an image pickup function or an electronic device module for image pickup built into such electronic devices.

### INDUSTRIAL APPLICABILITY

As explained above, according to the image processing circuit, image processing method, and camera device of the present invention, it is possible to suitably detect periodic color change phenomena such as color rolling or color flicker utilizing the image signal used in signal processing and without using any external sensors etc., to effectively reflect this back into auto white balancing control, to effectively remove color changes included in the input image, and to improve the quality of the output image signal, so the invention can be applied to a camera, mobile phone, personal computer (PC), or other electronic device having an image pickup function, an electronic device module for image pickup built into such electronic devices, or other camera system including a camera device.

1. An image processing circuit comprising:
a signal processing means for extracting prime color signals from an input image signal; and
a color change detecting means for detecting color changes included in the image signal based on integrated data of each prime color signal extracted by the signal processing means.

2. An image processing circuit as set forth in claim 1, wherein the color change detecting means detects periodic color changes.

3. An image processing circuit as set forth in claim 2, wherein the color change detecting means detects periodic color changes by a change of B signal with respect to R signal and G signal of the color signals.

4. An image processing circuit as set forth in claim 2, wherein the color change detecting means detects periodic color changes when a level of B signal among the color signals becomes smaller than a predetermined value and starts to become lager again.

5. An image processing circuit as set forth in claim 2, wherein the color change detecting means detects periodic color changes by monitoring changes of the integrated data of each color signal for each field of the image signal.

6. An image processing circuit as set forth in claim 2, wherein the circuit makes an auto white balancing control at the signal processing means automatically shift to a color change suppressing mode when periodic color changes are detected by the color change detecting means.

7. An image processing circuit as set forth in claim 6, wherein the circuit makes an auto white balancing control speed up at the color change suppressing mode.

8. An image processing circuit as set forth in claim 6, wherein the circuit makes an auto white balancing control speed up and suppresses signal gains of color components in the direction where periodic color changes occur.

9. An image processing method for processing an image signal comprising:
a first step of extracting prime color signals from the image signal;
a second step of calculating integrated data of each color signal based on the extracted prime color signals; and
a third step of extracting color changes included in the image signal based on changes in the integrated data of each color signal.

10. An image processing method as set forth in claim 9, wherein, in the third step, periodic color changes are detected.

11. An image processing method as set forth in claim 10, wherein, in the third step, periodic color changes are detected by a change of B signal with respect to R signal and G signal of the color signals.

12. An image processing method as set forth in claim 10, wherein, in the third step, periodic color changes are detected when a level of B signal among the color signals becomes smaller than a predetermined value and starts to become lager again.

13. An image processing method as set forth in claim 10, wherein, in the third step, periodic color changes are detected by monitoring changes of the integrated data of each color signal for each field of the image signal.

14. An image processing method as set forth in claim 10, wherein, in the third step, an auto white balancing control of the image signal is automatically shifted to a color change suppressing mode when periodic color changes are detected.

15. An image processing method as set forth in claim 14, wherein an auto white balancing control is speeded up at the color change suppressing mode.

16. An image processing method as set forth in claim 14, wherein an auto white balancing control is speeded up and suppressed color gains of color components in the direction where periodic color changes occur.

17. A camera device comprising:
an image pickup means for picking up an image of an object and outputting an image signal;
a signal processing means for extracting prime color images from the image signal output from the image pickup means;
a color signal detecting means for calculating integrated data for each color signal based on the prime color signals extracted by the signal processing means; and
a color change detecting means for detecting color changes included in the image signal based on changes of integrated data of each color signal calculated by the color signal detecting means.

18. A camera device as set forth in claim 17, wherein the color change detecting means detects periodic color changes.

19. A camera device as set forth in claim 18, wherein the color change detecting means detects periodic color changes by a change of B signal with respect to R signal and G signal of the color signals.

20. A camera device as set forth in claim 18, wherein the color change detecting means detects periodic color changes when a level of B signal among the color signals becomes smaller than a predetermined value and starts to become lager again.

21. A camera device as set forth in claim 18, wherein the color change detecting means detects periodic color changes by monitoring changes of the integrated data of each color signal for each field of the image signal.

22. A camera device as set forth in claim 18, wherein the circuit makes an auto white balancing control at the signal processing means automatically shift to a color change suppressing mode when periodic color changes are detected by the color change detecting means.

23. A camera device as set forth in claim 22, wherein the circuit makes an auto white balancing control speed up at the color change suppressing mode.

24. A camera device as set forth in claim 22, wherein the circuit makes an auto white balancing control speed up and suppresses color gains of color components in the direction where periodic color changes occur.
